(19) United States
(12) Patent Application Publication
(10) Pub. No.: US 2026/0134339 A1
(43) Pub. Date: May 14, 2026

(54) PREDICTION CIRCUITRY TRAINING

(71) Applicant: Arm Limited, Cambridge (GB)

(72) Inventors: Ugo CASTORINA, Biot (FR); Damien Matthieu Valentin CATHRINE, Mougins (FR); Gabriele CALIANNO, Antibes (FR); Geoffray Matthieu LACOURBA, Nice (FR)

(21) Appl. No.: 18/947,219

(22) Filed: Nov. 14, 2024

(51) Int. Cl. G06N 20/00

(52) U.S. Cl. CPC G06N 20/00

(57) ABSTRACT

An apparatus comprises training storage circuitry to store one or more training entries, each training entry associated with a target instruction and storing training data corresponding to the target instruction. Training circuitry is configured to update the training data of the one or more training entries based on monitoring sequences of instructions, and prediction circuitry is configured to make a prediction in respect of a given target instruction based on given training data corresponding to the given target instruction. Selection circuitry is configured to select which target instructions are associated with the one or more training entries of the training storage circuitry, wherein the selection circuitry is responsive to a determination that a candidate instruction is a biased instruction, to select the biased instruction with a higher priority for storage in a training entry of the training storage circuitry than at least one non-biased instruction.

### BACKGROUND

### TECHNICAL FIELD

The present technique relates to the field of data processing. More particularly, the present technique relates to training of prediction circuitry.

### Technical Background

A data processing apparatus may comprise prediction circuitry to make predictions in respect of instructions. Such predictions may be used for a range of purposes, including the prefetching of data or instructions to provide improved performance. The prediction circuitry may make predictions on the basis of data provided by training circuitry.

### SUMMARY

At least some examples of the present technique provide an apparatus, comprising:

training storage circuitry configured to store one or more training entries, each training entry associated with a target instruction and storing training data corresponding to the target instruction;

training circuitry configured to update the training data of the one or more training entries based on monitoring sequences of instructions;

prediction circuitry configured to make a prediction in respect of a given target instruction based on given training data corresponding to the given target instruction; and

selection circuitry configured to select which target instructions are associated with the one or more training entries of the training storage circuitry;

wherein the selection circuitry is responsive to a determination that a candidate instruction is a biased instruction, to select the biased instruction with a higher priority for storage in a training entry of the training storage circuitry than at least one non-biased instruction.

At least some examples provide a method, comprising:

storing one or more training entries in training storage circuitry, each training entry associated with a target instruction and storing training data corresponding to the target instruction;

updating the training data of the one or more training entries based on monitoring sequences of instructions;

making a prediction in respect of a given target instruction based on given training data corresponding to the given target instruction; and

selecting which target instructions are associated with the one or more training entries of the training storage circuitry; and

responsive to a determination that a candidate instruction is a biased instruction, selecting the biased instruction with a higher priority for storage in a training entry of the training storage circuitry than at least one non-biased instruction.

At least some examples provide computer-readable code for fabrication of an apparatus comprising:

training storage circuitry configured to store one or more training entries, each training entry associated with a target instruction and storing training data corresponding to the target instruction;

training circuitry configured to update the training data of the one or more training entries based on monitoring sequences of instructions;

prediction circuitry configured to make a prediction in respect of a given target instruction based on given training data corresponding to the given target instruction; and

selection circuitry configured to select which target instructions are associated with the one or more training entries of the training storage circuitry;

wherein the selection circuitry is responsive to a determination that a candidate instruction is a biased instruction, to select the biased instruction with a higher priority for storage in a training entry of the training storage circuitry than at least one non-biased instruction.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of a data processing apparatus;

FIG. 2 schematically illustrates prediction circuitry and circuitry for training the prediction circuitry;

FIGS. 3A and 3B provide example encodings of entries for training storage circuitry and training history storage circuitry;

FIG. 4 is a flow diagram illustrating a method of selecting instructions for storage in the training storage circuitry;

FIG. 5 is a flow diagram illustrating a particular example of selecting instructions for storage in the training storage circuitry;

FIG. 6 schematically illustrates inputs to selection circuitry; and

FIG. 7 illustrates a system and a chip-containing product.

### DESCRIPTION OF EXAMPLES

An apparatus comprises prediction circuitry configured to make a prediction in respect of a given target instruction. The prediction is not particularly limited and different implementations of the present techniques may provide different examples of prediction circuitry. In general, the prediction circuitry may be responsive to a trigger operation associated with the given target instruction to predict a subsequent event, such as fetching of a particular subsequent instruction (e.g., in the case of branch prediction) or the loading of certain data. The prediction circuitry may enable one or more operations to be speculatively performed on the basis of the prediction, such as prefetching of the predicted data or instruction into a cache, which can result in performance improvements. If the prediction is triggered by a trigger operation, then the trigger operation can be any type of operation. For example, the trigger operation may be identified by a program counter having a value corresponding to the given target instruction or receipt of an instruction pointer indicating the given target instruction. Alternatively, or in addition, the trigger operation may be a specific type of operation and/or an operation accessing a certain address or utilising a particular subset of the processing circuitry. In some configurations the trigger operation may occur when a program counter has a value of a load instruction previously identified as a potential producer load instruction, i.e., a load instruction which returns a base pointer from which one or more addresses to be used in one or more corresponding consumer loads may be derived.

The apparatus also comprises training storage circuitry configured to store one or more training entries, each training entry associated with a target instruction and storing training data corresponding to the target instruction, as well as training circuitry configured to update the training data of the one or more training entries based on monitoring sequences of instructions. A given training entry may be associated with a target instruction in various ways. For example, training entries may store key information identifying the associated target instruction, where such key information may be based on one or a combination of: a memory address at which the target instruction is stored, a virtual or physical address accessed in response to the target instruction, and so on.

The prediction circuitry is configured to make predictions based on the training data updated by the training circuitry. The prediction circuitry may make predictions based on entries in a prediction structure, where such entries may be populated with training data from the training storage circuitry and trained by the training circuitry, and hence the prediction circuitry may not make predictions directly using training data stored in the training storage circuitry. Nevertheless, as predictions are made on the basis of the training data, the training circuitry may update the training data of the one or more training entries to seek to improve the accuracy with which predictions can be made by the prediction circuitry using that training data. For example, the training circuitry may ensure that the training data is up to date and likely to be predictive of current workloads. The training circuitry may, for example, identify and update one or more relationships represented by the training data, where such relationships may be variously defined and may include, for example, a stride distance between an address accessed in response to the target instruction and one or more addresses accessed in further operations, and/or one or more producer-consumer relationships between the target instruction and one or more subsequent operations. Training may occur during a training period having a predefined duration which may be hardwired into the training circuitry or defined in a control register.

For area and power reasons it would not be practical to train every instruction at the same time, and therefore the apparatus comprises selection circuitry configured to select which target instructions are to be trained in the training storage circuitry at any given time. The target instructions associated with training entries in the training storage circuitry are the instructions for which the training data can be updated, and therefore the selection of which target instructions are allocated to those training entries may affect the success of the predictor training and therefore affect overall performance of the apparatus.

In one approach, which is an alternative to the present technique, the selection circuitry could select instructions for allocation in the training circuitry using a static sampling approach. According to such an approach, a particular training entry may be associated with a particular target instruction for a training period, and at the end of the training period the next item in an input stream may be selected to determine the target instruction for that training entry. The input stream can take a variety of forms, and may generally comprise a sequence of elements representing a sequence of operations performed by the apparatus. For example, the input stream may represent a sequence of memory access requests, such as a sequence of load instructions or store instructions or both. The input stream could represent memory access requests in various ways, such as by identifying the program counter values corresponding to a sequence of memory access instructions, a sequence of addresses (virtual or physical) being accessed, and so on. By selecting the next element at the end of a training period, instructions corresponding to elements at periodic spacing in the input stream may be selected for allocation to the training storage circuitry.

The inventors have recognised that this alternative approach may be associated with large variations in training success depending on the input stream. For example, static sampling of an input stream could lead to certain instructions being selected for training very frequently if they happen to correspond to a sampled element in the input stream, whilst other instructions may be selected much less frequently or not be selected at all. For instance, a certain element may occur periodically in an input stream. If the element occurs in the input stream with the same frequency as the sampling frequency (or a multiple thereof), then there may be resonance between the sampling period and the element, and the element may be either heavily sampled if each instance occurs at a sampled location in the input stream, or never sampled if each instance occurs at an unsampled location in the input stream. Hence, static sampling of instructions for allocation to the training storage circuitry can lead to a large variation in training success between instructions. Such variation can result in critical instructions being poorly trained and can hence result in performance losses.

Static sampling can also lead to large variations in training success between different runs of the same workload. For example, in an out-of-order processor the order of executed instructions could differ each time a particular item of code is executed, and hence statically sampling the input stream may lead to different selections of instructions for training in different occurrences of the same workload. Hence, the predictability of training time may be negatively impacted and this can make it difficult for a programmer to make decisions based on an expected training period.

According to examples of the present technique, the selection circuitry is responsive to a determination that a candidate instruction is a biased instruction, to select the biased instruction with a higher priority for storage in a training entry of the training storage circuitry than at least one non-biased instruction. Candidate instructions may be selected in various ways. Candidate instructions may for example correspond to every element in an input stream or some selection of elements in the input stream.

Hence, the selection circuitry does not statically select instructions for allocation to the training storage circuitry, but is able to make a selection decision which prioritises certain instructions over others for allocation to the training storage circuitry. This can hence prioritise training of certain biased instructions over training of other non-biased instructions. Examples of biased instructions will be discussed below and are not particularly limited, but in general biased instructions may be selected such that training of biased instructions may be associated with a greater improvement to overall performance, while non-biased instructions may be those for which training is expected to be associated with a lower performance improvement. Hence, configuring the selection circuitry to prioritise certain instructions for allocation to the training circuitry over other instructions can allow training data for the prediction circuitry to be generated faster and more predictably. This can stabilise and shorten convergence time of a prediction algorithm, reduce the likelihood of divergence (where training does not converge, e.g., due to an instruction never being sampled), and allow more efficient usage of the training storage circuitry leading to an effective increase in the size of the training storage circuitry.

The manner in which an instruction may be selected with a higher priority than another instruction for storage in the training entry may vary in different implementations of the technique. In general, an instruction with a higher priority may be more likely to be stored in the training storage circuitry than an instruction with a lower priority. For example, for instance when there are no available entries in the training storage circuitry and a biased candidate instruction has been identified, the selection circuitry may be configured to evict a victim instruction from a training entry of the training storage to accommodate a biased instruction having a higher priority for storage than the victim instruction. The victim instruction may be a non-biased instruction evicted to make room for the candidate instruction. However, in some examples the victim instruction may also be a biased instruction, for example having a lower priority for storage than the candidate biased instruction.

In some examples, the selection circuitry may be configured to allocate the biased instruction to a training entry in association with a protection indicator, the protection indicator indicating that the biased instruction has a higher priority for storage compared to at least one instruction which is not associated with the protection indicator. Once a biased instruction has been selected for training in the training storage circuitry, for instance because it is expected that training of that instruction will improve prediction performance, then it may be desired to reduce the likelihood of the instruction being removed from the training storage circuitry. Hence, biased instructions allocated to the training storage circuitry may be identified with a protection indicator, and the selection circuitry may consider the protection indicator when selecting a particular training entry for eviction. For example, if the selection circuitry is allocating an instruction to the training storage circuitry then an entry not associated with a protection indicator may be victimised in preference to an entry associated with a protection indicator.

In addition to the protection indicator identifying that a particular training entry has a higher priority for storage than a training entry not associated with a protection indicator, different types of protection indicator may be supported and the type of the protection indicator may be used to determine whether a particular training entry has a higher priority for storage than the candidate entry when determining whether the training entry can be evicted to provide a training entry for the candidate instruction. Hence, in addition to establishing a hierarchy between biased and non-biased instructions, the protection indicators may be used to provide a hierarchy between biased instructions, to support finer grained control over selection of which instructions are to be stored in the training storage circuitry.

In some examples, there may be one or more conditions which define whether a particular instruction is a biased instruction or not, and the selection circuitry may select target instructions for storage in the training storage circuitry depending on whether or not the instruction is biased. However, in other examples, the selection circuitry may be configured to determine that the candidate instruction is a biased instruction when the candidate instruction is associated with one of a plurality of bias conditions and the selection circuitry may be configured to select the biased instruction for storage in a training entry in the training storage circuitry with a priority depending on which of the plurality of bias conditions is associated with the candidate instruction. Hence, in some examples, biased instructions may be associated with one of a plurality of bias conditions and different biased instructions may have different priorities for storage in the training storage circuitry depending on which of the bias conditions is associated with those instructions.

As discussed above, there may be various conditions according to which the selection circuitry may consider a candidate instruction to be a biased instruction. In some examples, the selection circuitry may be configured to determine that the candidate instruction is a biased instruction when the candidate instruction satisfies a further training condition. The further training condition may be satisfied when a determination is made that overall performance of the prediction circuitry may be improved if the candidate instruction is allocated to the training storage circuitry to receive further training (by updating the training data associated with the candidate instruction). Hence, a candidate instruction may be a biased instruction when it is predicted that the candidate instruction would benefit from additional training. Preferentially selecting such instructions for storage in the training storage circuitry may improve prediction performance by prioritising training of instructions where such training is predicted to be associated with performance improvements, rather than, for example, using a training entry for training of an instruction which has previously received sufficient training. This can reduce the variation in training between instructions, which can improve overall prediction performance. By reducing the likelihood of further training instructions which have already received sufficient training this can also lead to more efficient usage of the training storage circuitry, effectively increasing the size of the training storage circuitry.

In some examples, the apparatus may comprise training history storage comprising one or more training history entries each associated with a target instruction previously allocated to the training storage circuitry and configured to record training data corresponding to the target instruction. When a training entry is evicted from the training storage circuitry (e.g., after a training period has completed, or to make room for a higher priority instruction) the training data stored in that training entry and associated with a particular target instruction may be stored in a training history entry of the training history storage associated with the same target instruction. In this way, the training history storage may enable the training data associated with an instruction to be maintained to allow the instruction to be trained multiple times. In some examples, determining that the further training condition is satisfied may comprise determining that the training history storage comprises a training history entry associated with the candidate instruction. A training history entry may only be allocated for a particular target instruction if the training data indicates certain positive results, such as identification of a relationship between the target instruction and a later instruction which may be used for prediction.

Hence, presence of a training history entry associated with a particular candidate instruction may suggest that it would be useful to perform further training of that candidate instruction, as positive results have previously been observed from training of that candidate instruction.

The further training condition may also or alternatively include several different aspects. In some examples, the training circuitry may update the training data to track relationships between the target instruction and one or more subsequent instructions (e.g., when the target instruction is a producer instruction and the one or more subsequent instructions are consumers of the data loaded by the producer instruction). In such cases, a particular candidate instruction may be associated with the further training condition when previous training of that instruction has identified a subsequent related instruction (one sampling phase has been carried out) but a further subsequent instruction needs to be identified to determine the index relationship between the target instruction and a subsequent instruction (e.g., if a slope-intercept formula is used to determine the index relationship, requiring at least two sampling phases). In other examples, the further training condition may be satisfied when the candidate instruction has recently been linked with a subsequent instruction (e.g., a consumer has been associated with the candidate instruction in a previous sampling period) but when further training is required to confirm the accuracy of the link.

In some examples, determining that the further training condition is satisfied may comprise determining that the candidate instruction has been stored in the training storage circuitry for less than a threshold amount of time. Prioritising training of instructions which have been trained for less than a threshold amount of time may improve overall performance by promoting training of instructions which have been selected less frequently for training, in particular favouring training of such instructions over instructions which may have previously received more training. This can provide more even training between instructions, which can both improve overall performance (especially if the less trained instructions are critical for performance) and reduce variability between repeated instances of a workload. The amount of time an instruction has been trained for could be measured in various ways. For example, if training takes place in defined training periods then this may be a count of the number of training periods for which the candidate instruction has been allocated to a training entry in the training storage circuitry. This could also be, for example, a number of times the candidate instruction has been selected for storage in the training storage circuitry, or a number of cycles for which the candidate instruction has been stored in the training storage circuitry. In addition, the threshold amount of time could be defined in various ways. In some examples, the threshold may be a predefined static threshold applied equally to all instructions. In other examples, the threshold may be a dynamic value which could be set by software or could vary depending on hardware settings. A higher threshold might enable a higher peak accuracy for predictions, at the cost of greater variability between instructions. In one example, when the predictions made by the prediction circuitry are used for prefetching, the dynamic value could vary according to a throttling mechanism such that the threshold might be higher when more accurate prefetching is desired.

In some examples comprising the training history storage, the training history entry associated with a particular target instruction may provide an indication of an amount of time that target instruction has been stored in the training storage circuitry (and hence how much training that instruction has undergone). Hence, when determining whether a candidate instruction is a biased instruction, the entry of the training history storage corresponding to that instruction can be queried to determine whether the candidate instruction has been stored in the training storage for more or less than the threshold amount of time.

Prioritising further training of instructions satisfying the further training condition can be useful, because this can prioritise training of less well trained instructions over training of sufficiently well trained instructions. However, biasing only instructions satisfying the further training condition, especially when this requires that the instruction has been previously trained at least once, may lead to undertraining of instructions which have not previously been trained at all. Hence, in some examples, the selection circuitry may be configured to also or alternatively determine that the candidate instruction is a biased instruction when the candidate instruction has not previously been allocated to the training storage circuitry and satisfies a new allocation condition. By biasing training entries in the training storage for instructions which have not previously been trained, this can increase the probability of identifying useful training data which may not have otherwise been identified if using a static sampling approach. This can therefore reduce the likelihood of divergence (where training does not converge to a certain performance value, e.g., coverage) by reducing the likelihood of instructions for which no predictions can be made. As will be discussed below, the new allocation condition may take various forms, although in general while an instruction which has not previously been trained at all may turn out to be useful (e.g. training of such an instruction may identify relationships which could be used to make predictions which might not have been identified if not for biasing that instruction), there is also a possibility that training of such an instruction may not be associated with any performance improvements (and the chance of this being the case might be higher than for instructions which have previously been trained and for which positive results have been identified), and hence it may be desirable to only allocate a relatively small number of training entries for training of instructions satisfying the new allocation condition to reduce the number of training entries occupied by instructions for which training may not bring significant performance improvements. Hence, the new allocation condition may be configured such that it is relatively infrequently satisfied.

For example, in some examples determining that the new allocation condition is satisfied may comprise determining that a probability threshold is met. The probability threshold may have a certain probability of being met (which may be independent of which instruction has been identified as the candidate instruction) to reduce the likelihood of the new allocation condition being satisfied and to hence maintain a relatively low number of training entries for storing previously untrained instructions. This could be implemented in various ways. For example, determining whether the probability threshold is met may comprise determining whether a variable filtering value meets some criterion. For example, this may comprise determining whether an output value of a linear-feedback shift register (LFSR), which may be updated each time a candidate instruction is identified, has a particular predetermined value. The LFSR may act as a pseudo random number generator, and hence this can act to reduce the likelihood of the new allocation condition being met for a given instruction. Alternatively, determining whether the probability threshold is met may for example comprise determining whether a counter incremented at intervals has reached a certain value, and so on.

In some examples, determining that the new allocation condition is satisfied may also or alternatively comprise determining that the training storage circuitry comprises fewer than a threshold number of training entries for which the target instruction was allocated whilst satisfying the new allocation condition. That is, the number of entries for storing training entries meeting the new allocation condition may be limited, and if there are already the threshold number of entries in the training storage circuitry then the new allocation condition may not be satisfied. This therefore prioritises training of a not-previously-trained instruction already allocated to a training entry in the training storage circuitry over a not-previously-trained candidate instruction. The inventors have realised that this can improve overall performance, because this can reduce the likelihood of a training entry (allocated by satisfying the new allocation condition) from being evicted prematurely, providing the best opportunity to identify new relationships which may be used for future predictions.

In some examples, the selection circuitry may be configured to allocate a candidate instruction for which the new allocation condition is satisfied to a given training entry in the training storage circuitry in association with a protection indicator indicating that the given training entry should not be replaced until the end of a training period. The use of a protection indicator may reduce the likelihood of a training entry allocated due to satisfying the new allocation condition from being evicted prematurely. The protection indicator used for candidate instructions satisfying the new allocation condition could be the same as the protection indicator used for candidate instructions satisfying the further training condition, although in some examples the protection indicator for a training entry for which the target instruction satisfied the new allocation condition may indicate a higher priority for storage in the training storage circuitry than a protection indicator for training entries for which the target instruction satisfied the further training condition. Prioritising the new allocation condition over the further training condition may improve overall predictor performance, as the performance improvements associated with identifying new relationships associated with a previously untrained instruction, and hence identifying new opportunities for prediction, may outweigh performance improvements associated with further training of instructions for which relationships may have already been identified.

As discussed above the nature of the prediction circuitry is not particularly limited. In some examples, the prediction circuitry may be responsive to observation of the given target instruction to make a prefetching prediction based on the given training data associated with the given target instruction to predict one or more prefetching addresses for generation of speculative memory access requests for retrieval of data into a local storage structure such as a cache. For instance, when the training data indicates that the given target instruction is predicted to be followed by one or more subsequent instructions or memory access requests, the prediction circuitry can facilitate prefetching of the relevant instructions or data into a cache for quicker future access.

As mentioned above, in some examples the selection circuitry may be configured to identify the candidate instruction by sampling an input stream corresponding to a sequence of instructions. The input stream may correspond for example to all or a subset (e.g., one or more particular types) of instructions fetched by the apparatus when executing a particular workload. The input stream may be filtered prior to sampling. The input stream may be sampled in various ways to identify the candidate instruction, such as sampling of every element in the input stream or a subset thereof.

In some examples, the selection circuitry may be responsive to a determination that the training storage circuitry already comprises an entry corresponding to the candidate instruction to suppress selecting the candidate instruction for storage in the training storage circuitry. Hence, rather than re-allocating a training entry for a particular target instruction stored in the training storage circuitry, existing training may be permitted to continue.

In some examples, the selection circuitry may be configured to prevent eviction of a victim instruction from a training entry of the training storage circuitry to accommodate a biased instruction having the same priority for storage as the victim instruction. Hence, if two instructions have the same priority for storage in the training storage circuitry, then the selection circuitry may favour the instruction already stored in the training storage circuitry to reduce the amount of thrashing in the training storage circuitry and providing sufficient time for training data to be generated for instructions in the training storage circuitry.

### Particular examples will now be described with reference to the Figures.

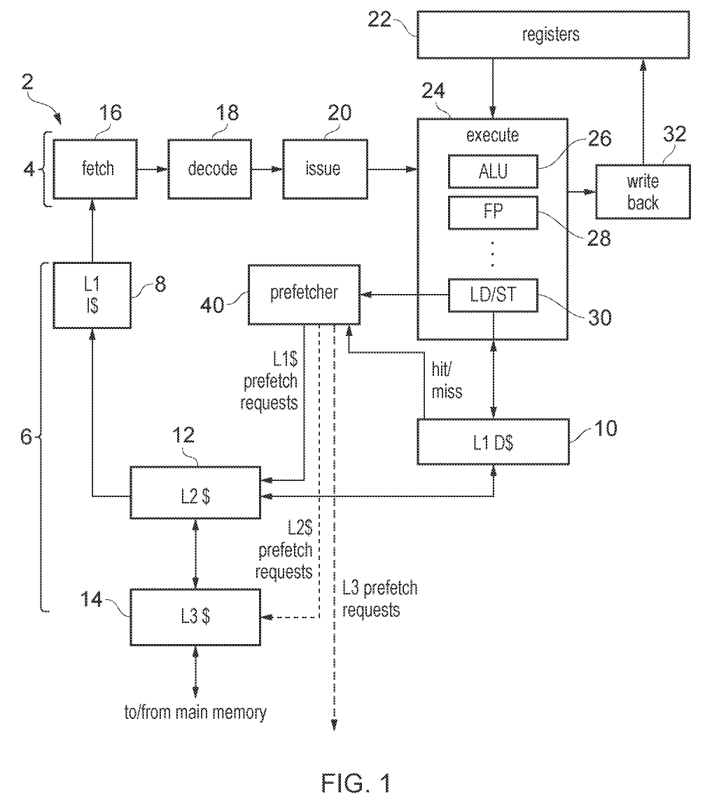

FIG. 1 illustrates an example of a data processing apparatus 2. The apparatus has a processing pipeline 4 for processing program instructions fetched from a memory system 6. The memory system in this example includes a level 1 instruction cache 8, a level 1 data cache 10, a level 2 cache 12 shared between instructions and data, a level 3 cache 14, and main memory which is not illustrated in FIG. 1 but may be accessed in response to requests issued by the processing pipeline 4. It will be appreciated that other examples could have a different arrangement of caches with different numbers of cache levels or with a different hierarchy regarding instruction caching and data caching (e.g. different numbers of levels of cache could be provided for the instruction caches compared to data caches).

The processing pipeline 4 includes a fetch stage 16 for fetching program instructions from the instruction cache 8 or other parts of the memory system 6. The fetched instructions are decoded by a decode stage 18 to identify the types of instructions represented and generate control signals for controlling downstream stages of the pipeline 4 to process the instructions according to the identified instruction types. The decode stage passes the decoded instructions to an issue stage 20 which checks whether any operands required for the instructions are available in registers 22 and issues an instruction for execution when its operands are available (or when it is detected that the operands will be available by the time they reach the execute stage 24). The execute stage 24 includes a number of functional units 26, 28, 30 for performing the processing operations associated with respective types of instructions. For example, in FIG. 1 the execute stage 24 is shown as including an arithmetic/logic unit (ALU) 26 for performing arithmetic operations such as add or multiply and logical operations such as AND, OR, NOT, etc. Also the execute unit includes a floating point (FP) unit 28 for performing operations involving operands or results represented as a floating-point number. Also the functional units include a load/store unit 30 for executing load instructions to load data from the memory system 6 to the registers 22 or store instructions to store data from the registers 22 to the memory system 6. Load requests issued by the load/store unit 30 in response to executed load instructions may be referred to as demand load requests. Store requests issued by the load/store unit 30 in response to executed store instructions may be referred to as demand store requests. The demand load requests and demand store requests may be collectively referred to as demand memory access requests. It will be appreciated that the functional units shown in FIG. 1 are just one example, and other examples could have additional types of functional units, or could have multiple functional units of the same type, or may not include all of the types shown in FIG. 1 (e.g. some processors may not have support for floating-point processing). The results of the executed instructions are written back to the registers 22 by a write back stage 32 of the processing pipeline 4.

It will be appreciated that the pipeline architecture shown in FIG. 1 is just one example and other examples could have additional pipeline stages or a different arrangement of pipeline stages. For example, in an out-of-order processor a register rename stage may be provided for mapping architectural registers specified by program instructions to physical registers identifying the registers 22 provided in hardware. Also, it will be appreciated that FIG. 1 does not show all of the components of the data processing apparatus and that other components could also be provided. For example, a branch predictor may be provided to predict outcomes of branch instructions so that the fetch stage 16 can fetch subsequent instructions beyond the branch earlier than if waiting for the actual branch outcome. Also a memory management unit could be provided for controlling address translation between virtual addresses specified by the program instructions and physical addresses used by the memory system.

As shown in FIG. 1, the apparatus 2 has a prefetcher 40 for analysing patterns of demand target addresses specified by demand memory access requests issued by the load/store unit 30, and detecting opportunities to generate prefetch load requests which are issued to the memory system 6 to request that data is brought into a given level of cache. The prefetch load requests are not directly triggered by a particular instruction executed by the pipeline 4, but are issued speculatively with the aim of ensuring that when a subsequent load/store instruction reaches the execute stage 24, the data it requires may already be present within one of the caches, to speed up the processing of that load/store instruction and therefore reduce the likelihood that the pipeline has to be stalled. The prefetcher 40 may be able to perform prefetching into a single cache or into multiple caches. For example, FIG. 1 shows an example of the prefetcher 40 issuing level 1 cache prefetch requests which are sent to the level 2 cache 12 or downstream memory and request that data from prefetch target addresses is brought into the level 1 data cache 10. Also the prefetcher 40 in this example can also issue level 3 prefetch requests to the main memory requesting that data from prefetch target addresses is loaded into the level 3 cache 14. The level 3 prefetch request may look a longer distance into the future than the level 1 prefetch requests to account for the greater latency expected in obtaining data from main memory into the level 3 cache 14 compared to obtaining data from a level 2 cache into the level 1 cache 10. In systems using both level 1 and level 3 prefetching, the level 3 prefetching can increase the likelihood that data requested by a level 1 prefetch request is already in the level 3 cache. However, it will be appreciated that the particular caches loaded based on the prefetch requests may vary depending on the particular circuit of implementation. The prefetcher may, in some configurations, predict access patterns based on a producer-consumer relationship between two memory access instructions. The prefetch generation circuitry can be of any form and use any algorithm to generate the prefetch requests.

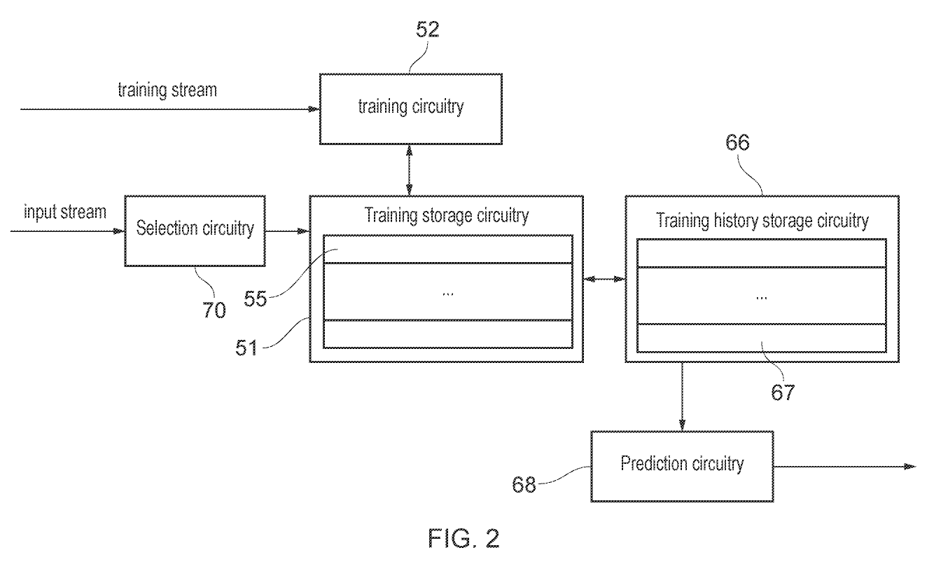

The prefetcher 40 shown in FIG. 1 is an example of prediction circuitry 68. FIG. 2 schematically illustrates prediction circuitry 68 and circuitry for training the prediction circuitry 68. FIG. 2 illustrates training storage circuitry 51 and training circuitry 52.

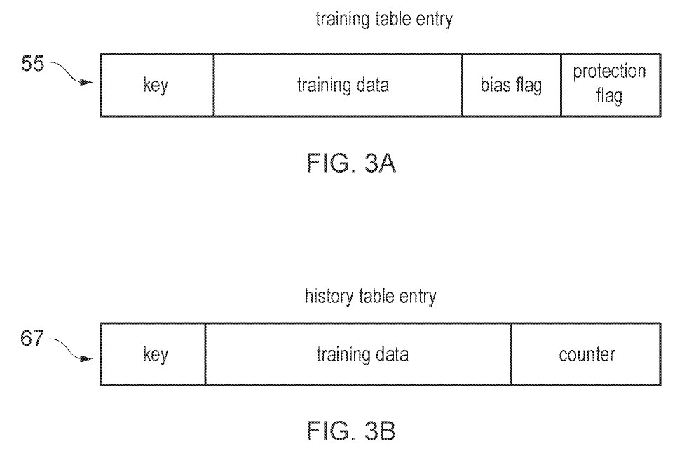

The training storage circuitry 51 includes storage for one or more training entries 55, an example of which is illustrated in FIG. 3A. FIG. 3A illustrates an example of a valid training table entry. It will be appreciated that the training table entries may comprise a valid field and if the valid field indicates that the entry is not valid then the invalid training entry may store no valid information. As shown in FIG. 3A, a valid training entry 55 comprises a key field identifying an operation, or target instruction, associated with that entry. The key field may identify the target instruction in various ways. For example, the key field may indicate the address of the target instruction in memory. If the target instruction is a memory access instruction associated with a memory access operation, the key field may identify an address (either virtual or physical) accessed by the target instruction. The training entry 55 also stores training data associated with the target instruction. The training data enables predictions to be made in respect of the target instruction. For example, the training data may indicate relationships between the target instruction and one or more operations expected to be observed after the target instruction, which could be used for example to issue prefetch requests for data associated with those operations.

The training circuitry 52 is configured to perform training to update the training entries 55 in response to a monitored sequence of operations, or training stream. The training circuitry is configured to perform the training for each of the entries to identify relationships between the target instruction and subsequent operations in the training stream to enable the prediction circuitry 68 to make predictions of future operations in response to observing the target instruction. For example, the training circuitry 52 may receive a training stream representing a sequence of operations and perform a lookup in the training storage circuitry 51 to determine whether any of the training entries 55 corresponds to a target instruction associated with the particular operation. If so, then the training circuitry may update the training data for the identified target instruction to represent relationships with subsequent operations in the training stream.

FIG. 2 also illustrates training history storage 66 comprising a plurality of training history entries 67, an example of which is illustrated in FIG. 3B. As shown in FIG. 3B, a valid training history entry 67 comprises a key field and training data, both of which may be in the same format as the data stored in the training entries 55. The training history entries correspond to target instructions, and can be used to store training data once it has been trained in the training storage circuitry 51. For example, once a training period has completed, the training data associated with a target instruction may be moved from the training storage circuitry 51 to the training history storage circuitry 66. In some examples, training data may only be stored in the training history storage circuitry 66 if some positive results have been identified which make that training data useful. If a particular instruction is trained more than once, then for subsequent training the training data may be initialised in the training entry 55 based on the data stored in the corresponding training history entry 67, allowing training data to be developed over several training periods.

The prediction circuitry 68 may make predictions on the basis of training data stored in either of the training circuitry 51 or the training history storage circuitry 66. The prediction circuitry 68 may for example receive an indication of a sequence of instructions being performed by the data processing apparatus, and may perform a lookup in the training history storage table based on the received operations. When an observed operation corresponds to a target instruction for which there is an associated entry in the training history storage circuitry, i.e., the lookup results in a hit in the training history storage circuitry, the training data stored in that entry is forwarded to the prediction circuitry 68 to be used to make a prediction and trigger one or more speculative operations based on the training data.

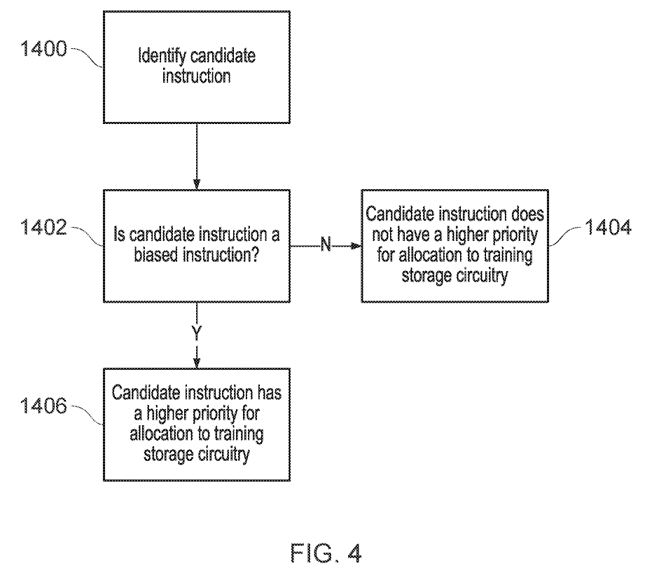

FIG. 2 also illustrates selection circuitry 70. The selection circuitry 70 selects which target instructions should be trained by the training circuitry 52, by determining which target instructions should be associated with the plurality of training entries 55. FIG. 4 illustrates a method used by the selection circuitry for selecting instructions for storage in the training storage circuitry.

At step 1400, the selection circuitry 70 identifies a candidate instruction. The candidate instruction may for example be identified from an input stream of elements associated with instructions. The input stream may in some examples be the same as the training stream used by the training circuitry, or it may differ. The input stream may for example represent virtual addresses accessed by load instructions, and the candidate instruction associated with a particular virtual address of the input stream may be the load instruction which triggered the request to load the data at that virtual address.

At step 1402 it is determined whether the candidate instruction is a biased instruction. This comprises determining whether the candidate instruction satisfies a bias condition.

For instance, it is determined whether the candidate instruction is associated with an entry 67 in the training history storage 66 and if so, whether the candidate instruction satisfies a further training condition. The further training condition comprises determining whether the candidate instruction has been trained for less than a threshold amount of time, and/or whether the candidate instruction is associated with a recently identified relationship which requires further training, and/or whether a further sample is required to establish a relationship between the candidate instruction and a subsequent operation. Determining whether the candidate instruction has been trained for less than a threshold amount of time can be performed based on the value stored by a training counter in the training history storage entry 67 corresponding to the candidate instruction, where the training counter may represent an amount of time (e.g., a number of training periods or otherwise) that the candidate instruction has been allocated to a training entry 55 in the training storage circuitry.

If the candidate instruction is not associated with the further training condition, it is determined whether the candidate instruction is associated with the new allocation condition. This comprises determining that the candidate instruction has no corresponding entry in the training history storage 66, and further that a new allocation condition is satisfied. The new allocation condition requires that the output of an LFSR has a predetermined value and that there are fewer than a threshold number of training entries 55 currently associated with instructions which satisfied the new allocation condition when they were allocated to the training storage circuitry.

If the candidate instruction is not a biased instruction, then at step 1404 the selection circuitry determines that the candidate instruction does not have a higher priority for storage in the training storage circuitry.

If the candidate instruction is a biased instruction, then at step 1406 the selection circuitry determines that the candidate instruction has a higher priority for storage in the training storage circuitry. This may comprise, for example, evicting a training entry 55 associated with a non-biased instruction to make space for the candidate instruction in the training storage circuitry.

A training entry 55 allocated for a biased instruction may have a protection indicator set to identify that the entry is associated with a biased instruction, to reduce the likelihood that the entry is evicted in future. FIG. 3A provides an example in which two types of protection indicator are provided, each as a separate flag, although it will be appreciated that this information could be represented in various ways such as using an single indicator with several states representing which protection indicator is set. In FIG. 3A, the protection indicators comprise a bias flag and a protection flag. The bias flag may be set when the training entry 55 has been allocated to an instruction satisfying the further training condition, and the protection flag may be set when the training entry 55 has been allocated to an instruction satisfying the new allocation condition. The bias flag and protection flag may indicate different levels of priority for storage in the training storage circuitry, with the protection flag indicating a higher level of priority.

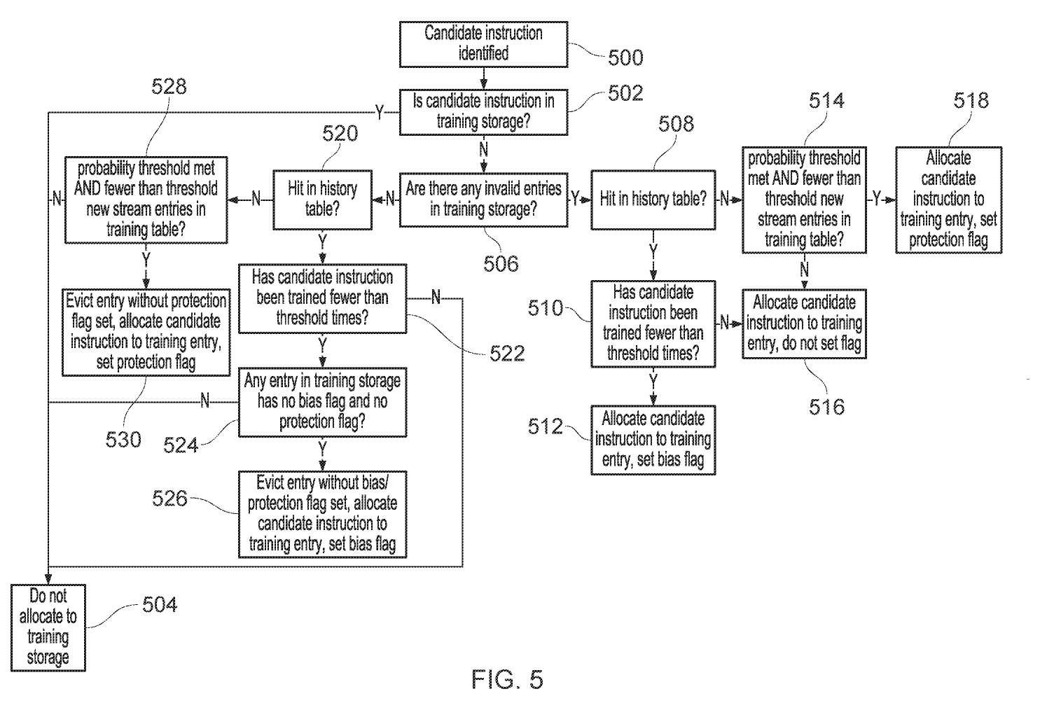

FIG. 5 is a flow diagram illustrating a particular example of selecting instructions for allocation in the training storage circuitry 51. At step 500 the selection circuitry identifies a candidate instruction from the input stream. At step 502, the selection circuitry performs a lookup to determine whether the candidate instruction has already been allocated to a training entry 55 in the training storage circuitry 51, and if so then at step 504 the selection circuitry decides not to allocate a new entry for the candidate instruction.

If there is no existing training entry 55 corresponding to the candidate instruction, then at step 506 it is determined whether there are any invalid entries in the training storage circuitry 51 (i.e., whether there is no need to evict a training entry to accommodate the candidate instruction).

If so, then at step 508 it is determined whether there is a training history entry 67 in the training history storage circuitry 66 corresponding to the candidate instruction, indicating that the candidate instruction has been trained previously. If there is a corresponding entry in the training history storage circuitry 66, then at step 510 the training counter value is retrieved from that entry and compared to a training threshold value to determine whether or not the further training condition is satisfied. If the candidate instruction has been trained for less time than the threshold, then the further training condition is satisfied and the candidate instruction is a biased instruction, and hence at step 512 the candidate instruction is allocated to a previously invalid training entry 55 and the bias flag is set.

If the candidate instruction has been trained the threshold number of times or more then the candidate instruction is not a biased instruction. Nevertheless, as there are available invalid entries in the training storage circuitry then a previously invalid training entry 55 is allocated for the candidate instruction at step 516 with no protection indicators are set.

If at step 508 it is determined that the candidate instruction does not have a corresponding entry in the history table, then this indicates that the candidate instruction has not previously been trained. At step 514 it is determined whether the new allocation condition is met be determining whether the output of an LFSR (or other value generator) meets a predetermined condition (e.g., has a particular value) and whether the total number of training entries 55 having the protection flag set is below a threshold. If these conditions are satisfied and the new allocation condition is hence satisfied, then at step 518 the selection circuitry treats the candidate instruction as a biased instruction and a previously invalid training entry 55 is allocated for the candidate instruction with the protection flag set. If these conditions are not satisfied, then the candidate instruction is not a biased instruction and a previously invalid training entry 55 is allocated for the candidate instruction at step 516 with no protection indicators set.

If it is determined at step 506 that there are no invalid training entries 55 in the training storage circuitry, then a training entry would need to be evicted to accommodate the candidate instruction in the training storage circuitry. In this case, at step 520 it is determined whether there is a training history entry 67 in the training history storage circuitry 66 corresponding to the candidate instruction, indicating that the candidate instruction has been trained previously. If there is a corresponding entry in the training history storage circuitry 66, then at step 522 the training counter value is retrieved from that entry and compared to a training threshold value to determine whether or not the further training condition is satisfied. If the candidate instruction has been trained for less time than the threshold, then the further training condition is satisfied and the candidate instruction is a biased instruction.

If the candidate instruction is not a biased instruction, then at step 504 it is determined not to allocate a new entry for the non-biased candidate instruction as doing so would require eviction of an entry having equal or higher priority.

At step 524 it is determined whether there are any training entries in the training storage circuitry having no bias flag or protection flag set. These entries correspond to non-biased instructions and hence have a lower priority for storage in the training storage circuitry than the biased candidate instruction. If there are no such entries, then at step 504 it is determined not to allocate a training entry 55 corresponding to the candidate instruction as there are no entries having a lower priority which can be evicted. However, if there is at least one entry corresponding to a non-biased instruction then at step 526 an entry without the bias flag or protection flag is evicted and the training entry is allocated for training the candidate instruction and the bias flag is set to identify that the candidate instruction satisfied the further training condition.

If at step 520 it was instead determined that the candidate instruction had not previously been trained, then at step 528 it is determined whether the new allocation condition is met for the candidate instruction using the same approach as in step 514. If the new allocation condition is not met, then the candidate instruction is not a biased instruction and at step 504 it is determined not to allocate a new entry for the candidate instruction. However, if the new allocation condition is met, then at step 530 the selection circuitry is configured to evict an entry which does not have the protection flag set, prioritising eviction of an entry without the bias flag set (although if required, in some examples evicting an entry having the bias flag set), and allocating a new training entry 55 for the candidate instruction, having the protection flag set.

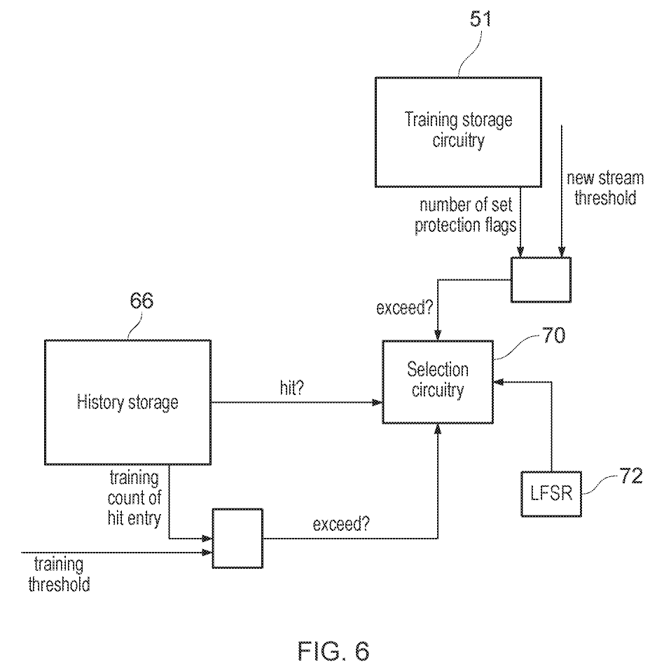

FIG. 6 schematically illustrates the selection circuitry 70 and some of the inputs which may be considered for determining whether a candidate instruction is a biased instruction. It will be appreciated that FIG. 6 is not exhaustive. The selection circuitry 70 may receive an input indicating whether the training history storage circuitry 66 comprises an entry corresponding to the candidate instruction (i.e., a hit signal from the training history storage circuitry), which can be used to determine whether the candidate instruction satisfies the further training condition. The selection circuitry 70 may also receive an input from a comparator indicating, in the case that the training history storage circuitry comprises an entry corresponding to the candidate instruction, whether the candidate instruction has been trained less than a threshold amount of time, which can be used to determine whether the candidate instruction satisfies the further training condition.

The selection circuitry 70 may also receive an input from a linear feedback shift register (LFSR) 72, which can be used to determine whether a candidate instruction satisfies the new allocation condition.

FIG. 6 also illustrates that the selection circuitry may receive an input from a comparator indicating whether the training storage circuitry 51 comprises greater than a threshold number of entries having the protection flag set, which can be used to determine whether a candidate instruction satisfies the new allocation condition.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

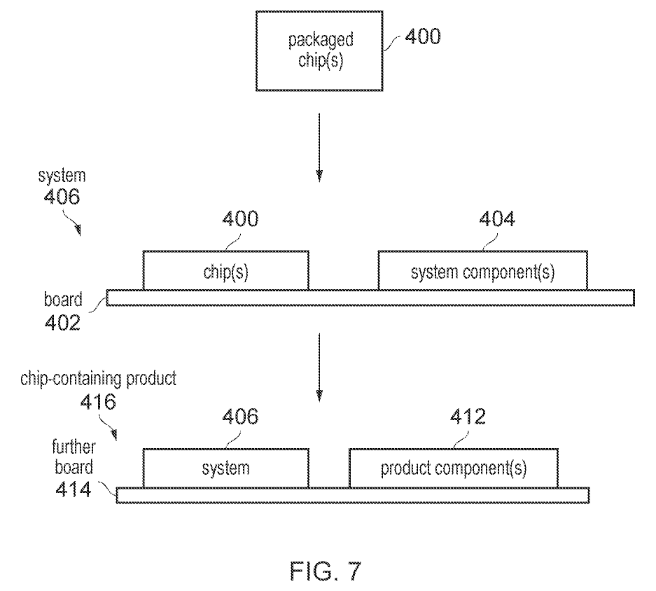

As shown in FIG. 7, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips which, when combined, provide the functionality of a chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:

1. An apparatus, comprising:

training storage circuitry configured to store one or more training entries, each training entry associated with a target instruction and storing training data corresponding to the target instruction;

training circuitry configured to update the training data of the one or more training entries based on monitoring sequences of instructions;

prediction circuitry configured to make a prediction in respect of a given target instruction based on given training data corresponding to the given target instruction; and

selection circuitry configured to select which target instructions are allocated to the one or more training entries of the training storage circuitry;

wherein the selection circuitry is responsive to a determination that a candidate instruction is a biased instruction, to select the biased instruction with a higher priority for storage in a training entry of the training storage circuitry than at least one non-biased instruction.

2. The apparatus according to clause 1, wherein the selection circuitry is configured to evict a victim instruction from a training entry of the training storage circuitry to accommodate a biased instruction having a higher priority for storage than the victim instruction.

3. The apparatus according to any preceding clause, wherein the selection circuitry is configured to allocate the biased instruction to a training entry in association with a protection indicator, the protection indicator indicating that the biased instruction has a higher priority for storage compared to at least one instruction which is not associated with the protection indicator.

4. The apparatus according to any preceding clause, wherein the selection circuitry is configured to determine that the candidate instruction is a biased instruction when the candidate instruction is associated with one of a plurality of bias conditions, and the selection circuitry is configured to select the biased instruction for storage in a training entry in the training storage circuitry with a priority depending on which of the plurality of bias conditions is associated with the candidate instruction.

5. The apparatus according to any preceding clause, wherein the selection circuitry is configured to determine that the candidate instruction is a biased instruction when the candidate instruction satisfies a further training condition.

6. The apparatus according to clause 5, comprising training history storage comprising one or more training history entries each associated with a target instruction previously allocated to the training storage circuitry and configured to record training data corresponding to the target instruction;

wherein determining that the further training condition is satisfied comprises determining that the training history storage comprises a training history entry associated with the candidate instruction.

7. The apparatus according to any of clauses 5 and 6, wherein determining that the further training condition is satisfied comprises determining that the candidate instruction has been stored in the training storage circuitry for less than a threshold amount of time.

8. The apparatus according to clause 7, comprising training history storage comprising one or more training history entries each associated with a target instruction previously allocated to the training storage circuitry and configured to record training data corresponding to the target instruction;

wherein a given training history entry is configured to provide an indication of an amount of time the associated target instruction has been stored in the training storage circuitry.

9. The apparatus according to any preceding clause, wherein the selection circuitry is configured to determine that the candidate instruction is a biased instruction when the candidate instruction has not previously been allocated to the training storage circuitry and satisfies a new allocation condition.

10. The apparatus according to clause 9, wherein determining that the new allocation condition is satisfied comprises determining that a probability threshold is met.

11. The apparatus according to any of clauses 9 and 10, wherein determining that the new allocation condition is satisfied comprises determining that the training storage circuitry comprises fewer than a threshold number of training entries for which the target instruction was allocated whilst satisfying the new allocation condition.

12. The apparatus according to any of clauses 9 to 11, wherein the selection circuitry is configured to allocate the candidate instruction for which the new allocation condition is satisfied to a given training entry in the training storage circuitry in association with a protection indicator indicating that the given training entry should not be replaced until the end of a training period.

13. The apparatus according to any preceding clause, wherein the prediction circuitry is responsive to observation of the given target instruction to make a prefetching prediction based on the given training data associated with the given target instruction to predict one or more prefetching addresses for generation of speculative memory access requests for retrieval of data into a local storage structure.

14. The apparatus according to any preceding clause, wherein the selection circuitry is configured to identify the candidate instruction by sampling an input stream corresponding to a sequence of instructions.

15. The apparatus according to any preceding clause, wherein the selection circuitry is responsive to a determination that the training storage circuitry already comprises an entry corresponding to the candidate instruction to suppress selecting the candidate instruction for storage in the training storage circuitry.

16. The apparatus according to any preceding clause, wherein the selection circuitry is configured to prevent eviction of a victim instruction from a training entry of the training storage circuitry to accommodate a biased instruction having the same priority for storage as the victim instruction.

17. A system comprising:

the apparatus of any preceding clause, implemented in at least one packaged chip;

at least one system component; and

a board,

wherein the at least one packaged chip and the at least one system component are assembled on the board.

18. A chip-containing product comprising the system of clause 17, wherein the system is assembled on a further board with at least one other product component.

19. A method, comprising:

storing one or more training entries in training storage circuitry, each training entry associated with a target instruction and storing training data corresponding to the target instruction;

updating the training data of the one or more training entries based on monitoring sequences of instructions;

making a prediction in respect of a given target instruction based on given training data corresponding to the given target instruction; and

selecting which target instructions are allocated to the one or more training entries of the training storage circuitry; and

responsive to a determination that a candidate instruction is a biased instruction, selecting the biased instruction with a higher priority for storage in a training entry of the training storage circuitry than at least one non-biased instruction.

20. Computer-readable code for fabrication of an apparatus comprising:

training storage circuitry configured to store one or more training entries, each training entry associated with a target instruction and storing training data corresponding to the target instruction;

training circuitry configured to update the training data of the one or more training entries based on monitoring sequences of instructions;

prediction circuitry configured to make a prediction in respect of a given target instruction based on given training data corresponding to the given target instruction; and

selection circuitry configured to select which target instructions are allocated to the one or more training entries of the training storage circuitry;

wherein the selection circuitry is responsive to a determination that a candidate instruction is a biased instruction, to select the biased instruction with a higher priority for storage in a training entry of the training storage circuitry than at least one non-biased instruction.

In the present application, the words “configured to…” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising:
training storage circuitry configured to store one or more training entries, each training entry associated with a target instruction and storing training data corresponding to the target instruction;
training circuitry configured to update the training data of the one or more training entries based on monitoring sequences of instructions;
prediction circuitry configured to make a prediction in respect of a given target instruction based on given training data corresponding to the given target instruction; and
selection circuitry configured to select which target instructions are associated with the one or more training entries of the training storage circuitry;
wherein the selection circuitry is responsive to a determination that a candidate instruction is a biased instruction, to select the biased instruction with a higher priority for storage in a training entry of the training storage circuitry than at least one non-biased instruction.

2. The apparatus according to claim 1, wherein the selection circuitry is configured to evict a victim instruction from a training entry of the training storage circuitry to accommodate a biased instruction having a higher priority for storage than the victim instruction.

3. The apparatus according to claim 1, wherein the selection circuitry is configured to select the biased instruction for storage in a training entry in association with a protection indicator, the protection indicator indicating that the biased instruction has a higher priority for storage compared to at least one instruction which is not associated with the protection indicator.

4. The apparatus according to claim 1, wherein the selection circuitry is configured to determine that the candidate instruction is a biased instruction when the candidate instruction is associated with one of a plurality of bias conditions, and the selection circuitry is configured to select the biased instruction for storage in a training entry in the training storage circuitry with a priority depending on which of the plurality of bias conditions is associated with the candidate instruction.

5. The apparatus according to claim 1, wherein the selection circuitry is configured to determine that the candidate instruction is a biased instruction when the candidate instruction satisfies a further training condition.

6. The apparatus according to claim 5, comprising training history storage comprising one or more training history entries each associated with a target instruction previously allocated to the training storage circuitry and configured to record training data corresponding to the target instruction;
wherein determining that the further training condition is satisfied comprises determining that the training history storage comprises a training history entry associated with the candidate instruction.

7. The apparatus according to claim 5, wherein determining that the further training condition is satisfied comprises determining that the candidate instruction has been stored in the training storage circuitry for less than a threshold amount of time.

8. The apparatus according to claim 7, comprising training history storage comprising one or more training history entries each associated with a target instruction previously allocated to the training storage circuitry and configured to record training data corresponding to the target instruction;
wherein a given training history entry is configured to provide an indication of an amount of time the associated target instruction has been stored in the training storage circuitry.

9. The apparatus according to claim 1, wherein the selection circuitry is configured to determine that the candidate instruction is a biased instruction when the candidate instruction has not previously been allocated to the training storage circuitry and satisfies a new allocation condition.

10. The apparatus according to claim 9, wherein determining that the new allocation condition is satisfied comprises determining that a probability threshold is met.

11. The apparatus according to claim 9, wherein determining that the new allocation condition is satisfied comprises determining that the training storage circuitry comprises fewer than a threshold number of training entries for which the target instruction was allocated whilst satisfying the new allocation condition.

12. The apparatus according to claim 9, wherein the selection circuitry is configured to select the candidate instruction for which the new allocation condition is satisfied for storage in a given training entry in the training storage circuitry in association with a protection indicator indicating that the given training entry should not be replaced until the end of a training period.

13. The apparatus according to claim 1, wherein the prediction circuitry is responsive to observation of the given target instruction to make a prefetching prediction based on the given training data associated with the given target instruction to predict one or more prefetching addresses for generation of speculative memory access requests for retrieval of data into a local storage structure.

14. The apparatus according to claim 1, wherein the selection circuitry is configured to identify the candidate instruction by sampling an input stream corresponding to a sequence of instructions.

15. The apparatus according to claim 1, wherein the selection circuitry is responsive to a determination that the training storage circuitry already comprises an entry corresponding to the candidate instruction to suppress selecting the candidate instruction for storage in the training storage circuitry.

16. The apparatus according to claim 1, wherein the selection circuitry is configured to prevent eviction of a victim instruction from a training entry of the training storage circuitry to accommodate a biased instruction having the same priority for storage as the victim instruction.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method, comprising:
storing one or more training entries in training storage circuitry, each training entry associated with a target instruction and storing training data corresponding to the target instruction;
updating the training data of the one or more training entries based on monitoring sequences of instructions;
making a prediction in respect of a given target instruction based on given training data corresponding to the given target instruction; and
selecting which target instructions are associated with the one or more training entries of the training storage circuitry; and
responsive to a determination that a candidate instruction is a biased instruction, selecting the biased instruction with a higher priority for storage in a training entry of the training storage circuitry than at least one non-biased instruction.

20. A non-transitory computer-readable medium storing computer-readable code for fabrication of an apparatus comprising:
training storage circuitry configured to store one or more training entries, each training entry associated with a target instruction and storing training data corresponding to the target instruction;
training circuitry configured to update the training data of the one or more training entries based on monitoring sequences of instructions;
prediction circuitry configured to make a prediction in respect of a given target instruction based on given training data corresponding to the given target instruction; and
selection circuitry configured to select which target instructions are associated with the one or more training entries of the training storage circuitry;
wherein the selection circuitry is responsive to a determination that a candidate instruction is a biased instruction, to select the biased instruction with a higher priority for storage in a training entry of the training storage circuitry than at least one non-biased instruction.
